(19) United States
(12) Patent Application Publication
(10) Pub. No.: US 2017/0136428 A1
(43) Pub. Date: May 18, 2017

(54) EXTERNALLY MOUNTED ADJUSTABLE NOZZLE ASSEMBLY

(71) Applicant: Vaughan Company, Inc., Montesano, WA (US)

(72) Inventors: Glenn R. Dorsch, Aberdeen, WA (US); Kent H. Keeran, Elma, WA (US); Alex Cahoon, Olympia, WA (US); Erik Larson, Aberdeen, WA (US)

(21) Appl. No.: 15/064,037

(22) Filed: Mar. 8, 2016

Related U.S. Application Data
(60) Provisional application No. 62/254,416, filed on Nov. 12, 2015.

(51) Int. Cl. B01F 13/02; B05B 1/22

(52) U.S. Cl. CPC B01F 13/0283; B01F 13/0233; B01F 13/0205; B05B 1/22

(57) ABSTRACT

An externally mounted tank nozzle assembly which can be used in many mixing systems. The assembly can be installed as a fixed nozzle or as an externally adjustable nozzle. The disclosed nozzle is light-weight, corrosion-resistant as well as abrasion-resistant to withstand many tank mixing environments and conditions.

### RELATED APPLICATION

The present application claims the filing priority of U.S. Provisional Application No. 62/254,416, titled “Externally Mounted Adjustable Nozzle Assembly” and filed on Nov. 12, 2015. The disclosure of the '416 Provisional application is also incorporated herein by reference.

### TECHNICAL FIELD OF THE INVENTION

The present invention relates to tank mixing systems. Specifically, the invention relates to an adjustable nozzle assembly which can be mounted from and adjusted from a tank exterior even while the mixing pump is running and flow is going through the nozzle.

### BACKGROUND OF THE INVENTION

The need for effective tank mixing systems has existed for many years. Many industries rely on the ability to keep fluids within a tank in a fairly homogenous state for various reasons. However, one size or type of mixing system does not work for all industries and mixing applications. Problems have existed with many prior art nozzle mixing systems, and new problems continually arise.

For example, some nozzle systems are made of heavy, hardened steel. However, steel nozzles may corrode over time, requiring occasional replacement. Other metal nozzles are subject to high-degradation during use due to excessive abrasion from grit and debris entrained within the liquid. Many installations use tank floor-mounted mixing systems because the heavy nozzles and the forces involved can stress a thin-walled tank, such as fiberglass and some steel tanks. Unfortunately, floor-mounted nozzles must also include piping along the tank floor which can interfere with and diminish mixing effectiveness.

In addition to the stressing of tank sidewalls, mounting on the tank wall is not without its problems. Typically, the mixing nozzles must be mounted from the interior of the tank. This can be a “confined space” and will usually have very strict safety procedures for entering. Once mounted, the nozzle assemblies must occasionally be loosened from the tank wall (again from the interior of the tank) and redirected to increase mixing effectiveness. Sometimes the nozzles will need to be aimed upwards within the tank to address upper surface scum and sometimes the nozzles will need to be aimed downward to address settled grit on the tank floor.

In fact, industry experience has led to the determination that many problems of prior art tank mixing systems relate to (1) interference with mixing or diminished mixing efficiency due to tank floor mounting or positioning of equipment, (2) convenience and safety issues due to a need for occasional replacement of internally mounted nozzles, (3) tank wall stress due to the weight of nozzles, and (4) inability to easily and conveniently redirect nozzles. Until the invention of the present application, these and other problems in the prior art went either unnoticed or unsolved by those skilled in the art. The embodiments of the present external nozzle system provide effective tank mixing without sacrificing reliability, adjustability and affordability.

### SUMMARY OF THE INVENTION

There is disclosed herein improved mixing nozzle assembly and methods for a tank mixing system which affords cost and operating advantages.

Generally speaking, the mixing nozzle assembly is for use on smaller mixing tank systems having limited tank wall integrity for heavy nozzles as well as limited space for internal nozzle adjustment. The basic assembly comprises a nozzle having a flanged end, a mounting pipe with a flanged end, and a feed pipe with a flanged end. The three components are coupled in one of two manners to alleviate tank wall stress and allow external mounting and movement of the nozzle.

In a specific embodiment, the nozzle assembly comprises a nozzle having a discharge end, a receiving end, and a flanged wheel extending radially from the receiving end of the nozzle, a mounting pipe attached by a first end to an exterior of a wall of the tank and having a flange radially extending from a second end, and a feed pipe attached to a fluid source by a first end and having a flange radially extending from a second end. In this embodiment, the nozzle is positioned to pass through the mounting pipe extending to an interior of the tank and the flanged wheel is positioned between the mounting pipe flange and the feed pipe flange.

In an alternate embodiment, the tank nozzle assembly further comprises two mounting plates with one positioned on each side of the flanged wheel between the mounting pipe flange and the feed pipe flange. This mounting configuration allows movement of the nozzle, via the flanged wheel, without disconnecting from the mounting pipe or feed pipe and while the mixing pump is in operation.

An aspect of an embodiment of the invention provides a lightweight nozzle comprised of an outer layer and an inner layer of polyurethane. Preferably, the outer layer is comprised of a higher strength, stiffer polyurethane material and the inner layer is comprised of a more abrasion-resistant polyurethane material.

In an embodiment of a full mixing system, the assembly is united with a fluid source, a pump positioned between the fluid source and the tank, and the feed pipe being fluidly coupled to the pump by a first end.

Finally, in a method for mixing contents of a mixing tank having a peripheral wall, the method comprises the steps of mounting a mixing nozzle through the tank wall, the mixing nozzle comprising a discharge end extending to an interior of the mixing tank and an input end having a flange extending radially there from, coupling a feed pipe to the input end of the nozzle on the exterior of the tank, and pumping fluid from a fluid source through the feed pipe and nozzle and discharging the fluid from the discharge end of the nozzle into the tank in a direction to create mixing of the tank contents.

The disclosed method for mixing contents of a mixing tank may further include the step of allowing the flange of the mixing nozzle to be rotated from the exterior of the tank to change the direction of the discharge within the tank during the mixing process.

These and other aspects of the invention may be understood more readily from the following description and the appended drawings.

### BRIEF DESCRIPTION OF THE DRAWINGS

For the purpose of facilitating an understanding of the subject matter sought to be protected, there are illustrated in the accompanying drawings, embodiments thereof, from an inspection of which, when considered in connection with the following description, the subject matter sought to be protected, its construction and operation, and many of its advantages should be readily understood and appreciated.

FIG. 1 is perspective view of a mixing tank and pump using an embodiment of the disclosed external mounted nozzle assembly;

FIG. 2 is a cut-away view of an embodiment of the nozzle assembly as it would appear in an interior tank wall;

FIG. 3 is an inlet side view of the embodiment of FIG. 1;

FIG. 4 is a discharge side view of the embodiment of FIG. 1;

FIG. 5 is a side cross-section and end view of an embodiment of a nozzle and handle;

FIG. 6 is a side cross-section and end view of an embodiment of an external mounting plate;

FIG. 7 is a top view of the mixing tank and nozzle assembly shown in FIG. 6 with arrows to illustrate the mixing flow in two dimensions;

FIGS. 8-11 are a sequence of side views through a transparent tank wall illustrating adjustment of the nozzle in the direction of the curved arrow with the discharge directed as shown by the straight arrow;

FIG. 12 is a perspective view an embodiment of the nozzle and handle;

FIGS. 13a and 13b illustrate an adjustable installation of the nozzle assembly; and

FIGS. 14a and 14b illustrate a fixed installation of the nozzle assembly.

### DETAILED DESCRIPTION OF THE INVENTION

While this invention is susceptible of embodiments in many different forms, there is shown in the drawings and will herein be described in detail at least one preferred embodiment of the invention with the understanding that the present disclosure is to be considered as an exemplification of the principles of the invention and is not intended to limit the broad aspect of the invention to any of the specific embodiments illustrated.

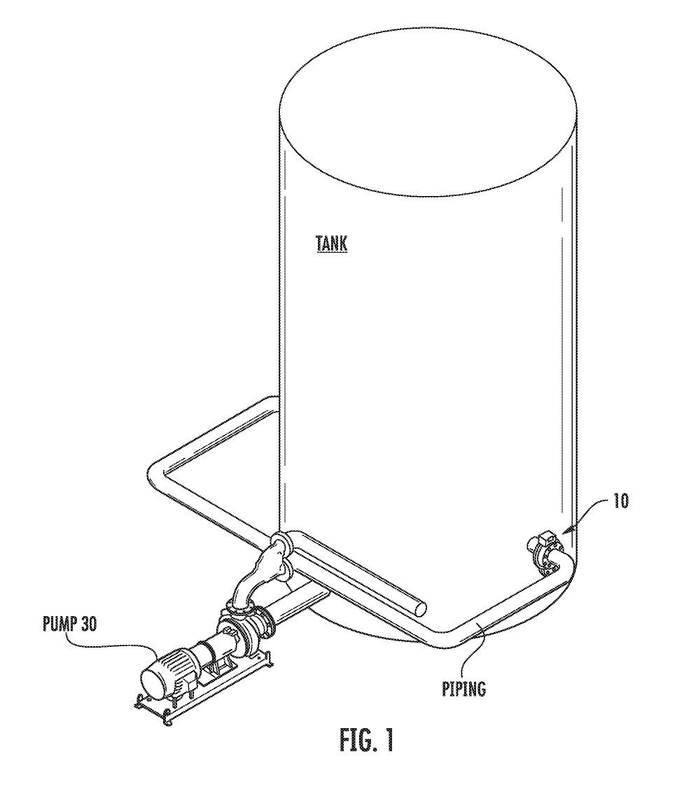

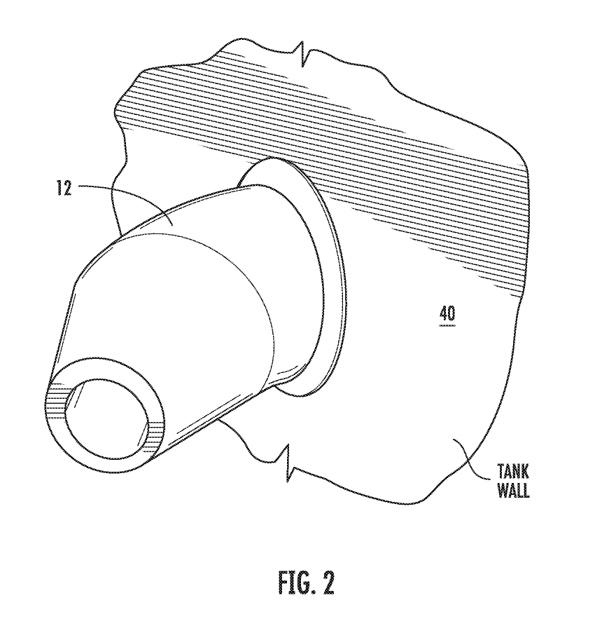

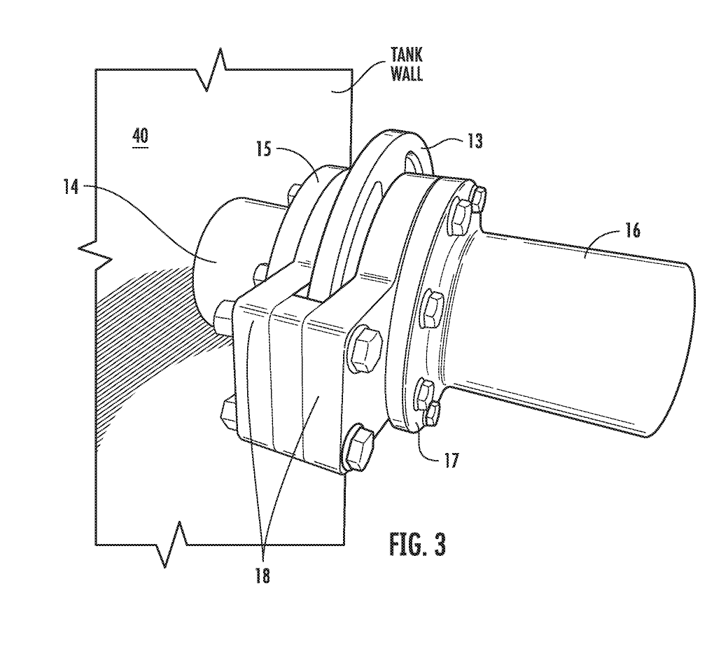

Referring to FIGS. 1-14, there are illustrated embodiments of a nozzle assembly, referenced by the numeral 10, for mounting to a tank wall 40 of a mixing tank. The nozzle assembly 10 is intended to be mounted externally to the tank wall 40. The nozzle assembly 10 is comprised of a nozzle 12, a mounting pipe 14, a feed pipe 16, and a pump 30. The nozzle 12, mounting pipe 14 and feed pipe 16 each preferably includes a radially extending flange 13, 15 and 17, respectively, at one end. Additionally, for a more preferred embodiment, as shown in FIGS. 13A and B, two mounting plates 18 may be used for mounting of the nozzle 12 to the mounting pipe 14 and feed pipe 16.

The disclosed nozzle assembly 10 has many advantages over prior art nozzle assemblies. While not exhaustive, some of the advantages are that the disclosed nozzle assembly: 1) is lightweight to prevent stressing up a thin-walled tank, such as fiberglass or steel tanks; 2) is corrosion resistant; 3) is abrasion resistant; 4) mounts externally to the tank so that an installer does not have to enter the tank, a confined space area with very strict safety procedures for entering; 5) can be rotated from outside the tank without loosening any bolts or fittings or flanges, making the nozzle 12 capable of being externally aimed so it can mix settled grit on the floor of a tank or it can mix floating scum at the upper surface, depending on the direction nozzle 12 is pointed; 6) keeps piping off the tank floor making the mixing system more effective; and, 7) nozzle can be re-aimed while mixing. Additional advantages may be realized through application of the disclosed nozzle assembly 10 to address specific tank mixing needs.

Referring to FIGS. 1-4, the mounting pipe 14 and flange 15 are used to mount the nozzle 12 to the tank wall 40 by bolting to the flange 13 of the nozzle 12. The feed pipe flange 17 is also bolted to the assembly by sandwiching the nozzle flange 13 with the mounting pipe flange 15. By inserting mounting plates 18, the mounting pipe flange 15 and feed pipe flange 17 bolt to the plates 18 and leave the nozzle flange 13 to “float” in the assembly 10, as explained below.

The mounting pipe 14 and feed pipe 16 are both comprised of suitable steel material, while the mounting plates 18 are preferably comprised of polyurethane. The nozzle 12 is also preferably comprised of polyurethane and is mounted with an internal O-ring configuration to seal. In fact, most preferably the nozzle 12 is made from two types of polyurethane.

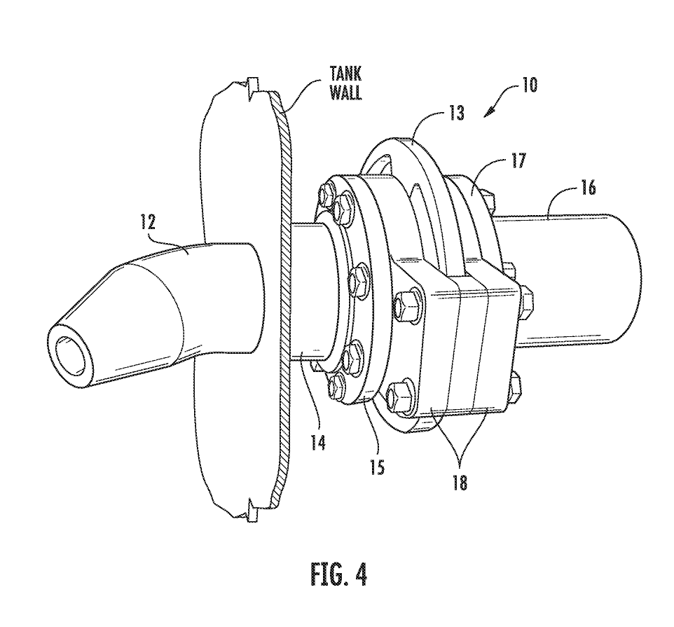

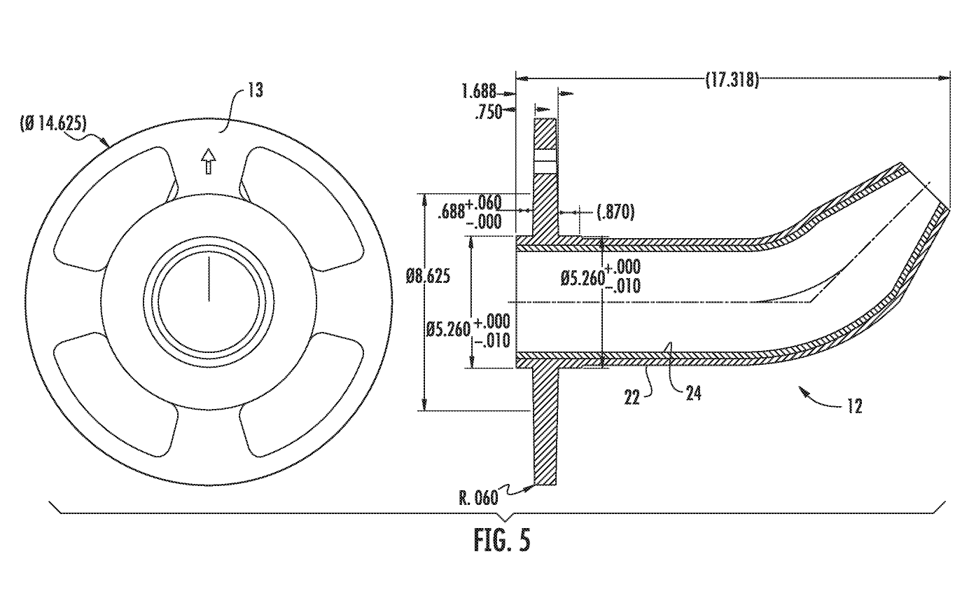

As shown in FIG. 5, an outer shell 22 is preferably comprised of a harder, stiffer material that provides enough rigidity so that the nozzle 12 holds its shape under flow and pressure, while an inner lining 24 is preferably comprised of a softer but much more abrasion resistant material having an 80-90 durometer hardness, making the nozzle 12 more abrasion resistant. More specifically, the embodiment shown in FIG. 5 is a composite polyurethane small tank mixing (STM) nozzle, made in accordance with the present invention and intended to replace current steel or stainless steel STM nozzle designs. The composite consists of two layers of polyurethane bonded together: a rigid outer shell 22 and a durable, wear-resistant inner lining 24. The nozzle 12 features an integral flange (aka hand wheel) 13 for nozzle aiming and is backwards compatible with previous STM nozzle installations. The illustrated dimensions of the nozzle 12 and flange 13 are preferred for the described embodiment only. Other dimensions are certainly possible for larger and smaller mixing tank applications.

In other alternate embodiments, the nozzle 12 could be made of metal, such as stainless steel for some applications. However, as mentioned, making nozzle 12 out of polyurethane materials reduces weight and increases abrasion resistance. Such an embodiment is believed to best achieve the objects of the present system.

The disclosed nozzle assembly 10 is expected to be particularly effective for small tank mixing, such as for mixing septage or FOG (fats, oils, & grease), or possibly for applications for a sludge blending tank located upstream of an anaerobic digester. The oil industry also has need of the nozzle assembly 10 for mixing tanks at tank farms, for seawater disposal, and for oil recovery at hydraulic fracturing sites.

Referring to FIG. 6, the mounting plate 18 is illustrated. The two mounting plates 18 are preferably comprised of polyurethane material, similar to the nozzle 12. The plates 18 include holes for mounting to the flanges 15 and 17, as well as extended sections for bolting to one another. Other materials, configurations and dimensions are possible, depending on the application and mixing tank system.

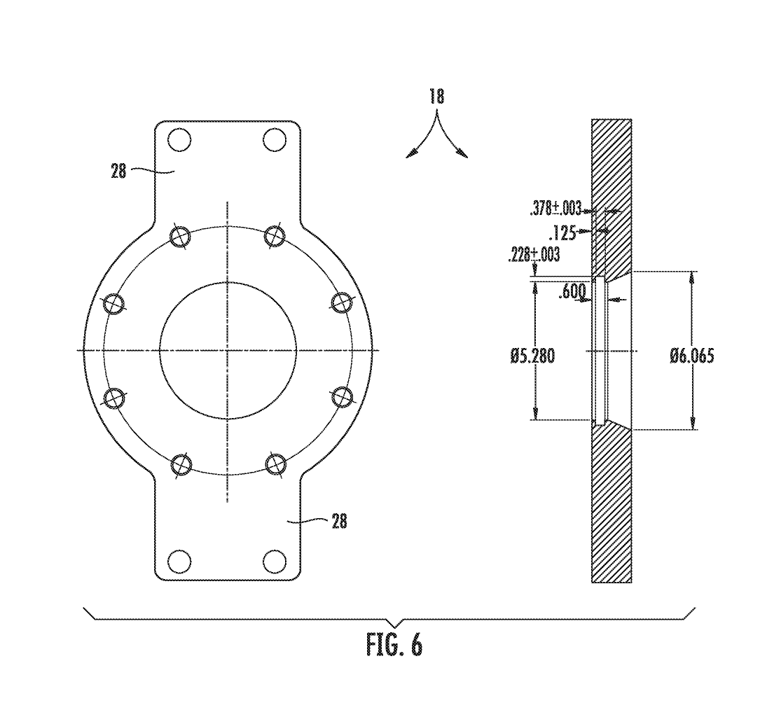

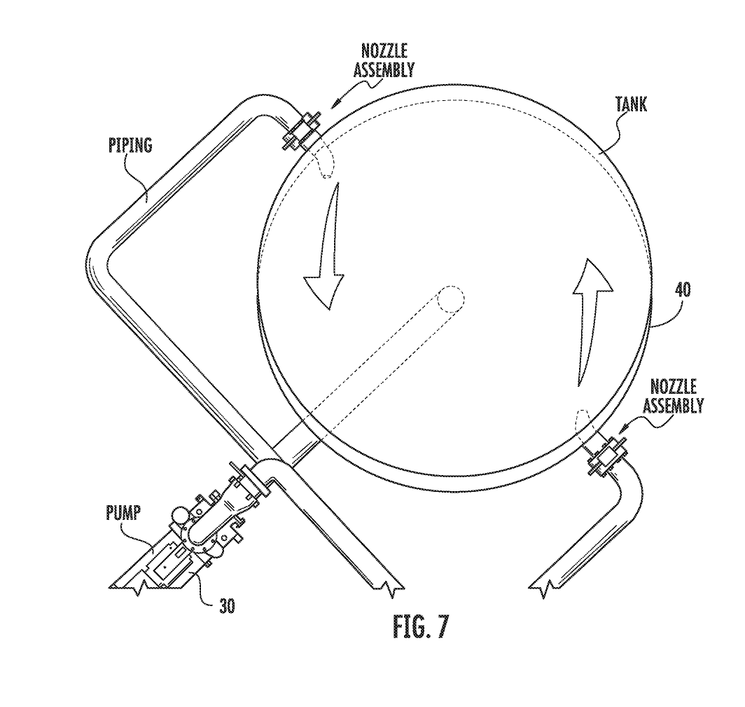

As shown in FIGS. 7-11, illustrating an installation of the nozzle assembly 10, the assembly 10 is externally mounted with only the discharge end of the nozzle 12 passing through the tank wall 40 and extending into the tank. As shown, the nozzle 12 is attached to a standard six-inch pipe stub having a six-inch ANSI 150# flange (mounting pipe 14 and flange 15) located on the outside of the tank. The nozzle 12 is long enough that when mounted on the stub flange 15, the nozzle 12 extends through the inside of the six-inch stub of mounting pipe 14 to the inside of the tank where mixing flow can be introduced.

The nozzle flange 13 is sandwiched between the mounting pipe flange 15, which is attached to the mix tank wall 40, and another six-inch 150# ANSI flange 17 that is part of the feed pipe 16 which brings flow to the nozzle 12. A suitable pump 30, such as those pumps sold by assignee of the present invention, Vaughan Company of Montesano, Wash. (see http://www.chopperpumps.com/applications/), is to be used to pump liquid through the nozzle assembly 10 and into the tank, as illustrated in FIG. 7.

Installation Types

Currently, there are two preferred methods of installation: Adjustable and Fixed. These two methods are described further below.

Adjustable—With reference to FIGS. 13A and 13B, this method of installation allows for easy adjustment of the nozzle 12 through manual turning of the hand wheel (aka flange 13) to a desired orientation. In addition to the two pipe flanges, 15 and 17, the nozzle flange 13 is installed “floating” between two mounting plates 18 and is sealed by the use of two O-rings (not shown). The mounting plates 18 are bolted to the two pipe flanges, 15 and 17, and are held together by bolts at tabs 28 extending from a periphery of the plates 18. Obviously, many configurations are possible to permit the nozzle flange 13 to “float” for rotation and such configurations are intended to fall within the scope of the present disclosure.

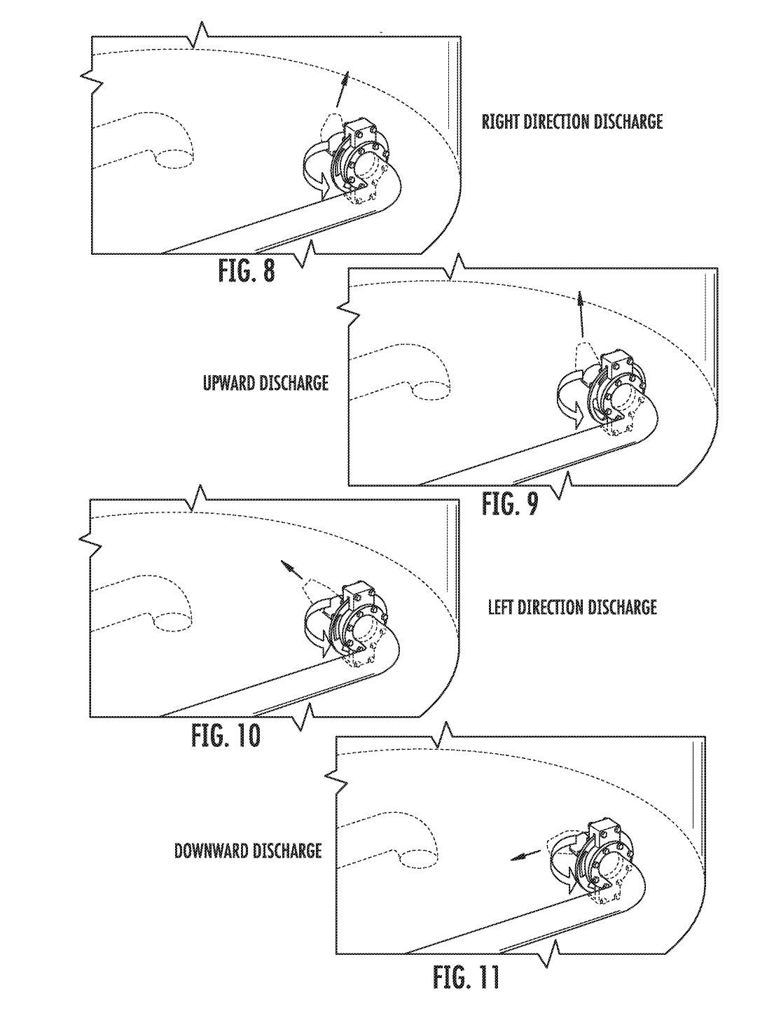

An advantage of this mounting orientation is that the nozzle direction can be adjusted without requiring shutdown and disassembly. As illustrated in the sequence of FIGS. 8-11, the wheel (flange 13) can be turned to direct the nozzle discharge to the right (FIG. 8), upward (FIG. 9), to the left (FIG. 10) and downward (FIG. 11). This is beneficial in applications where, for example, tank mixing, bottom sediment and surface debris (e.g., scum) may all be an issue. The nozzle 12 can be readily altered for effective periods between an upward direction—moving surface debris—and a downward direction—moving bottom sediment—and a left or right direction—for effective tank mixing—without anyone ever having to enter the tank or shut down the mixing pump.

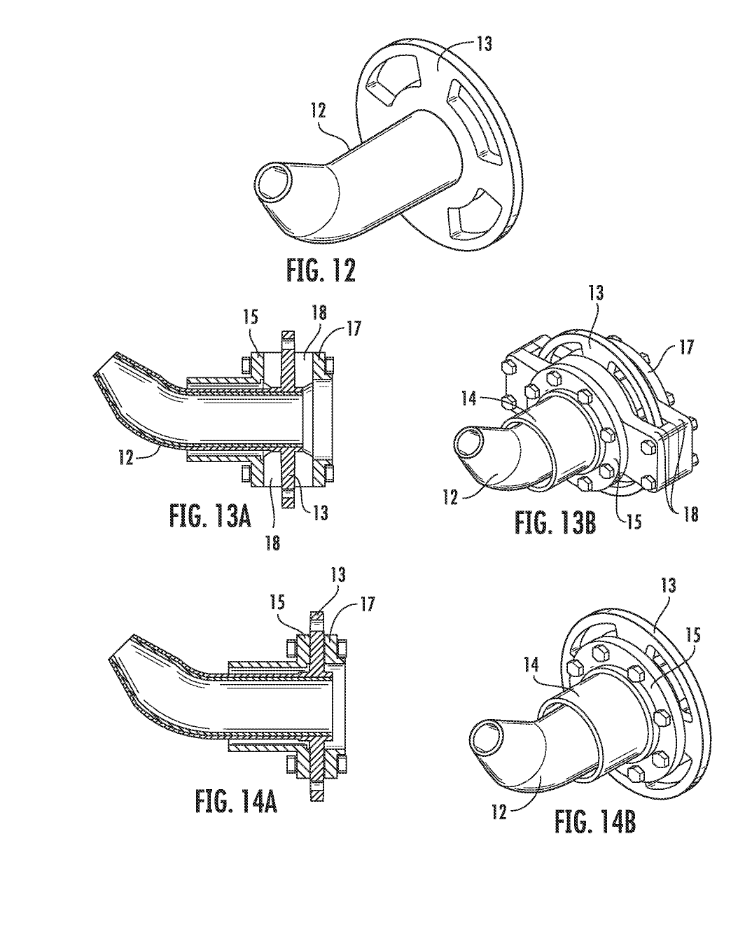

Fixed—This installation method is very similar to existing installations and is illustrated in FIGS. 14A and 14B. The nozzle 12 is installed to be aimed in a desired direction and this orientation is held in place by bolting the flange 13 between the two pipe flanges, 15 and 17. Sealing gaskets (not shown) are preferably used to seal the nozzle flange 13 to the faces of the pipe flanges, 15 and 17. External adjustment of the nozzle direction is still possible in this configuration. However, the flanges 13, 15 and 17, must be unbolted/fastened to change the orientation.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A tank nozzle assembly mounted to a tank, the assembly comprising:
a nozzle having a discharge end, a receiving end, and a flanged wheel extending radially from the receiving end of the nozzle;
a mounting pipe attached by a first end to an exterior of a wall of the tank and having a flange radially extending from a second end; and
a feed pipe attached to a fluid source by a first end and having a flange radially extending from a second end;
wherein the nozzle is positioned to pass through the mounting pipe extending to an interior of the tank and the flanged wheel is positioned between the mounting pipe flange and the feed pipe flange.

2. The tank nozzle assembly of claim 1, further comprising two mounting plates with one positioned on each side of the flanged wheel between the mounting pipe flange and the feed pipe flange.

3. The tank nozzle assembly of claim 2, wherein the flanged wheel is rotatable between the two mounting plates.

4. The tank nozzle assembly of claim 1, wherein the nozzle is fixed in a desired orientation and held in place by fixing the flanged wheel between the mounting pipe flange and the feed pipe flange.

5. The tank nozzle assembly of claim 1, wherein the nozzle is comprised of an outer layer and an inner layer.

6. The tank nozzle assembly of claim 5, wherein the outer layer is comprised of a corrosion-resistant high-strength material and the inner layer is comprised of an abrasion-resistant material.

7. The tank nozzle assembly of claim 5, wherein the nozzle is comprised of two types of polyurethane, a first polyurethane for the outer layer, and a second polyurethane having an 80-90 durometer hardness for the inner layer.

8. An exteriorly mounted mixing system for a tank having a peripheral wall, the system comprising:
a mounting pipe attached by a first end to an exterior of the tank wall forming a passage there through and having a flange radially extending from a second end;
a nozzle having a discharge end which passes through the wall of the tank via the mounting pipe and extends into the tank interior to allow discharging of a mixing fluid, a receiving end positioned on an exterior of the tank wall, and a flange extending radially from the receiving end of the nozzle;
a fluid source;
a pump positioned between the fluid source and the tank; and
a feed pipe fluidly coupled to the pump by a first end and having a flange radially extending from a second end;
wherein the nozzle flange is positioned between the mounting pipe flange and the feed pipe flange on the exterior of the tank.

9. The exteriorly mounted mixing system of claim 8, wherein the nozzle is comprised of polyurethane.

10. The exteriorly mounted mixing system of claim 9, wherein the nozzle is comprised of an inner layer of polyurethane and an outer layer of a different type of polyurethane.

11. The exteriorly mounted mixing system of claim 8, further comprising two mounting plates with one positioned on each side of the flanged wheel between the mounting pipe flange and the feed pipe flange.

12. The exteriorly mounted mixing system of claim 11, wherein the nozzle flange is rotatable between the two mounting plates.

13. The exteriorly mounted mixing system of claim 12, wherein each of the two mounting plates is attached to one of either the mounting pipe flange and the feed pipe flange.

14. The exteriorly mounted mixing system of claim 8, wherein the nozzle flange is fixed in position by securing to at least one of either the mounting pipe flange and the feed pipe flange.

15. The exteriorly mounted mixing system of claim 14, wherein the nozzle flange is secured to both the mounting pipe flange and the feed pipe flange.

16. A method for mixing contents of a mixing tank having a peripheral wall, the method comprising the steps of:
mounting a mixing nozzle through the tank wall, the mixing nozzle comprising a discharge end extending to an interior of the mixing tank and an input end having a flange extending radially there from;
coupling a feed pipe to the input end of the nozzle on the exterior of the tank; and
pumping fluid from a fluid source through the feed pipe and nozzle and discharging the fluid from the discharge end of the nozzle into the tank in a direction to create mixing of the tank contents.

17. The method for mixing contents of a mixing tank as set forth in claim 16, further comprising the step of allowing the flange of the mixing nozzle to be rotated from the exterior of the tank to change the direction of the discharge within the tank.

18. The method for mixing contents of a mixing tank as set forth in claim 16, wherein the mixing nozzle is mounted through the tank wall via a mounting pipe having a flanged end.

19. The method for mixing contents of a mixing tank as set forth in claim 18, wherein the flange of the mixing nozzle is fixed to the flanged end of the mounting pipe.

20. The method for mixing contents of a mixing tank as set forth in claim 17, further comprising the step of periodically rotating the flange of the mixing nozzle from the exterior of the tank.
